(19) United States
(12) Patent Application Publication
(10) Pub. No.: US 2025/0170744 A1
(43) Pub. Date: May 29, 2025

(54) METHOD FOR MANUFACTURING HARDWOOD NOSING

(71) Applicant: Espenson Furniture, LLC, Whitefish, MT (US)

(72) Inventor: Ryan Espenson, Whitefish, MT (US)

(21) Appl. No.: 18/523,744

(22) Filed: Nov. 29, 2023

(51) Int. Cl. B27M 3/12

(52) U.S. Cl. CPC B27M 3/12

(57) ABSTRACT

A method for manufacturing hardwood nosing, comprising: confirming stair opening or landing surround measurements onsite; cut the flooring board to be used to create the nose; run two pieces of tape the length of the flooring board on the face of the flooring with a center line of each piece of tape approximately arranged at the centerline of each miter cut as illustrated; set up a shaper to remove the material from the flooring board to create the miter fold; calibrate the depth of the cut; and create the miter.

### TECHNICAL FIELD

The embodiments described herein are generally directed to hardwood nosing, and more particularly to, methods for manufacturing folded hardwood nosing.

### BACKGROUND

When a home or building comprises hardwood stairs, it is common to also include hardwood nosing that extends over the edge of the stairs for a smooth transition between stairs. Making such hardwood nosing, however, can be a labor intensive project that can result in inconsistencies between the stairs and the nosing.

The present disclosure is directed toward overcoming one or more of the problems with conventional processes for making and installing hardwood nosing.

### SUMMARY

Systems and methods for manufacturing and installing hardwood nosing are disclosed herein. According to one aspect, a method for manufacturing hardwood nosing, comprising: confirming stair opening or landing surround measurements onsite; cut the flooring board to be used to create the nose; run two pieces of tape the length of the flooring board on the face of the flooring with a center line of each piece of tape approximately arranged at the centerline of each miter cut as illustrated; set up a shaper to remove the material from the flooring board to create the miter fold; calibrate the depth of the cut; and create the miter.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 illustrates a flow chart for manufacturing hardwood nosing, according to an embodiment;

FIG. 2 illustrates the step of taping the hardwood flooring, according to an embodiment;

FIG. 3 illustrates the step of pressing the tape, according to an embodiment;

FIG. 4 illustrates the step of setting up the shaper, according to an embodiment;

FIG. 5 illustrates example cutters;

FIG. 6 further illustrates the step of setting up the shaper, according to an embodiment;

FIG. 7 further illustrates the step of setting up the shaper, according to an embodiment; and

FIG. 8 illustrates the step of cutting the miter, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments can be practiced without these specific details. In some instances, well-known structures and components are shown in simplified form for brevity of description.

For clarity and ease of explanation, some surfaces and details may be omitted in the present description and figures.

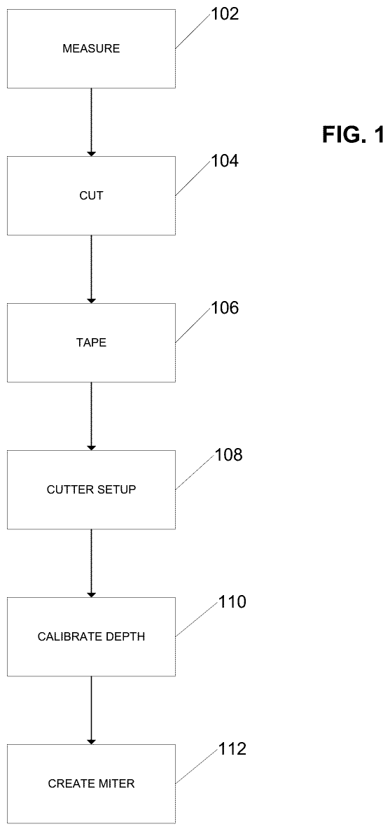

FIG. 1 is a flow chart illustrating an example process for manufacturing hardwood nosing in accordance with one example embodiment. As can be seen, in step 102, the stair opening or landing surround measurements should be taken/confirmed onsite. Once measurements are taken and material has been acquired the final tight measurement taken on site is increased by at least 2″, i.e., if the stair opening is 40″ the piece to be manufactured should be at least 42″. In other embodiments the measurement can be increased by no more than 2″. In other embodiments, the measurement can be increased by at least 4″. In other embodiments, the measurement can be increased by no more than 4″.

The flooring board 201 to be used to create the nose will often have a tongue on one side and a groove on the other. The flooring board 201 being used to create the nose can then be cut in step 104. If the flooring board 201 is, e.g., less than 14″ over the required nosing size it does not need to be cross cut to length. If the flooring board 201 is, e.g., over 14″ longer than the desired length the flooring plank can be cross cut to length. The leftover piece that will not be turned into a nose should contain the factory produced end tongue so that if the installer chooses to use it they only have to cut the groove onsite.

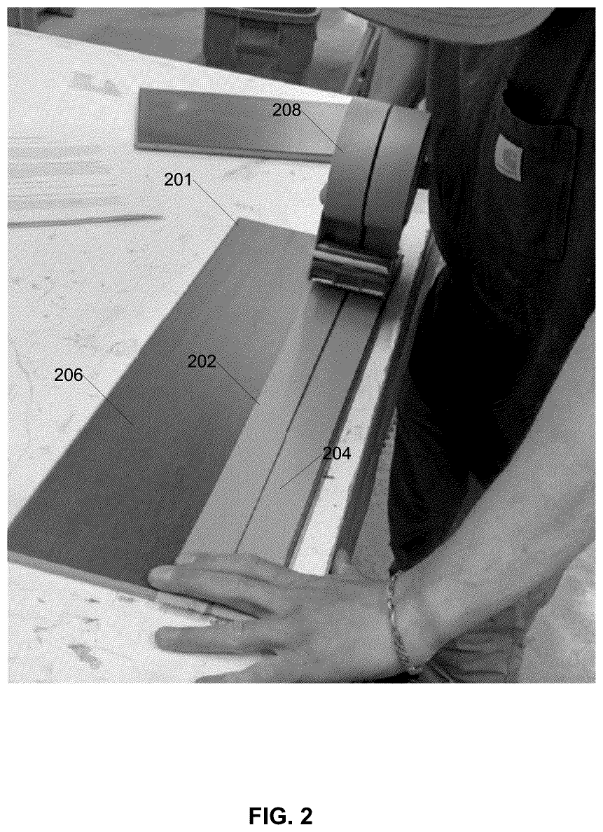

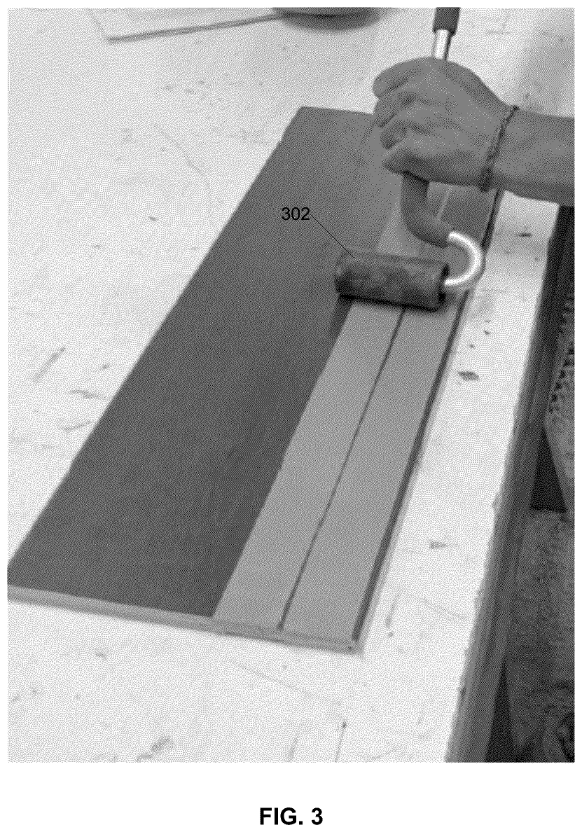

Once the flooring board 201 has been cut to size two pieces of masking tape (202 and 204) should be run the length of the flooring board 201 on the face 206 of the flooring with the center line of each piece of tape (202, 204) approximately arranged at the centerline of each double miter cut as illustrated in FIG. 2 and step 106. Typically, the center lines are at 1″ and 2-½″ from the edge referenced on the shaper table being used. After the tape has been placed on the flooring board 201 it needs to be pressed on firmly using, e.g., the butt of the hand or a laminate pressure roller 302 as illustrated in FIG. 3. The tape will later act as a hinge for the product to fold against as described in detail below.

The tape can for example be applied using a 3″ tape dispenser 208, as illustrated in FIG. 2, loaded two rolls of 1.44″ with a ⅛th shim between them and a keeper on the outside edge to allow the user to install both pieces of tape at the same time. At present, the Frogtape™ brand is the only tape that has proven to be strong enough to hold while being delicate enough to not pull finish from prefinished material, which is a requirement for the tape being used.

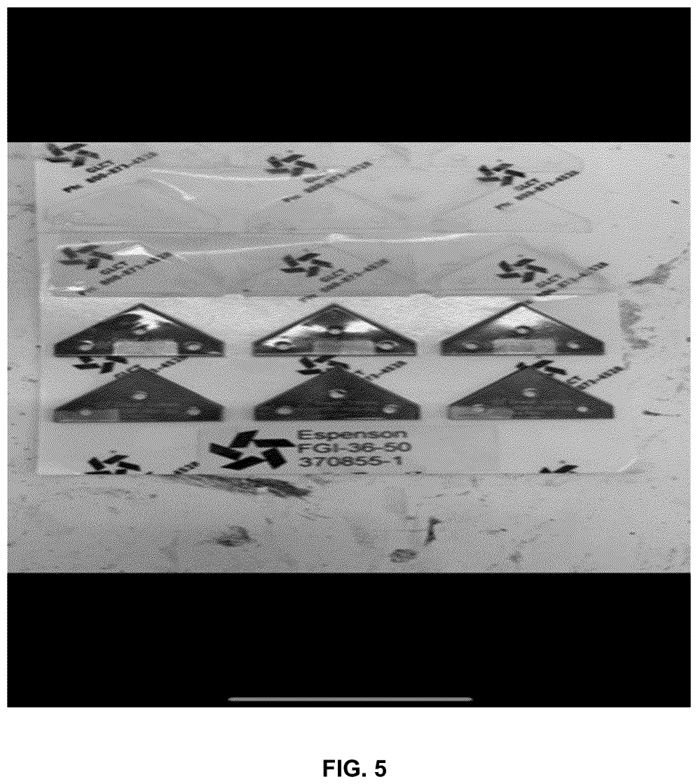

Once the flooring board 201 has been taped it is then time to set up a shaper to remove the material from the flooring board to create the miter fold in step 108. It should be noted that the modified Double Profile cutter from Great Lakes Custom Tool (product number 230-70287-0000 with custom carbide inserts product number 810-70287-0000DLC), illustrated in FIG. 5, can cut both miters in only one pass.

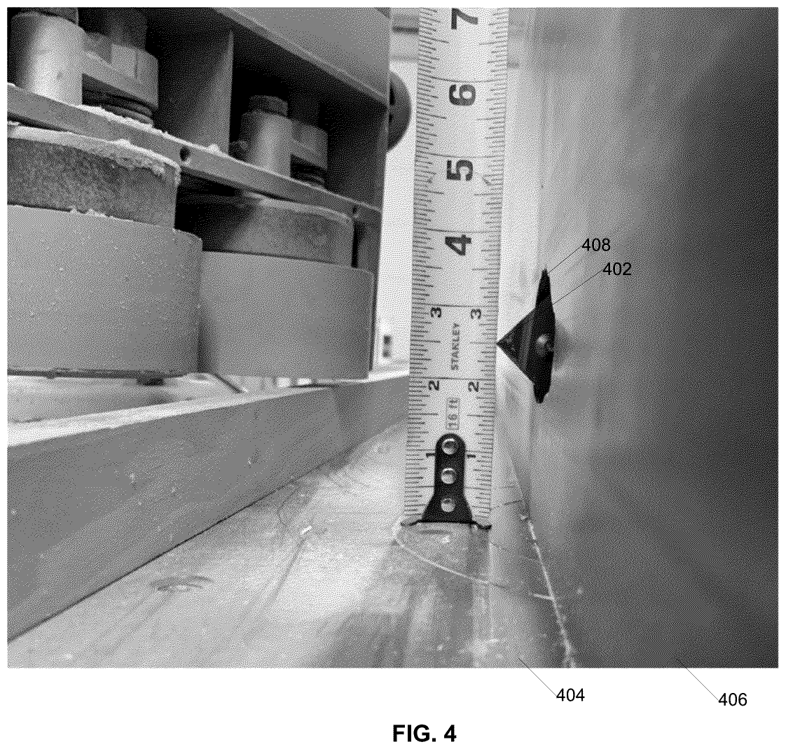

The shaper should be set up with a custom built 3 wing cutter head. In the example of FIG. 4, the apex of the cutter 402 is set at 2-½″ from the table top 404 of the shaper. The fence 406 of the shaper has a sacrificial fence added to it. The fence 406 should be made of ¾″ engineered product with a slick face surface such as prefinished maple plywood or Formica covered plywood. Where the shaft of the shaper aligns with the sacrificial fence a relief 408 should be cut in the back of the fence to allow the cutter 402 to protrude through the fence 406. With the cutter 402 and inserts installed and set at, e.g., 2-½″ and the sacrificial fence 406 attached to the stock fence turn the shaper on and slowly allow the cutter 402 to plunge through the sacrificial fence until the inserts are protruding to the maximum thickness of material desired to be cut as illustrated in FIG. 4. This gives the least amount of opening for the cutter 402 to come through the sacrificial fence thus leaving the most amount of fence 404 remaining for the flooring to ride on with minimal opening to flex into.

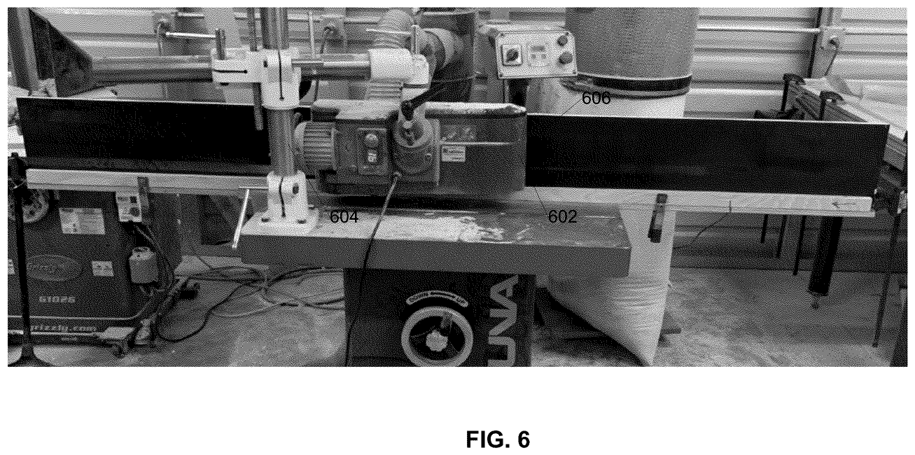

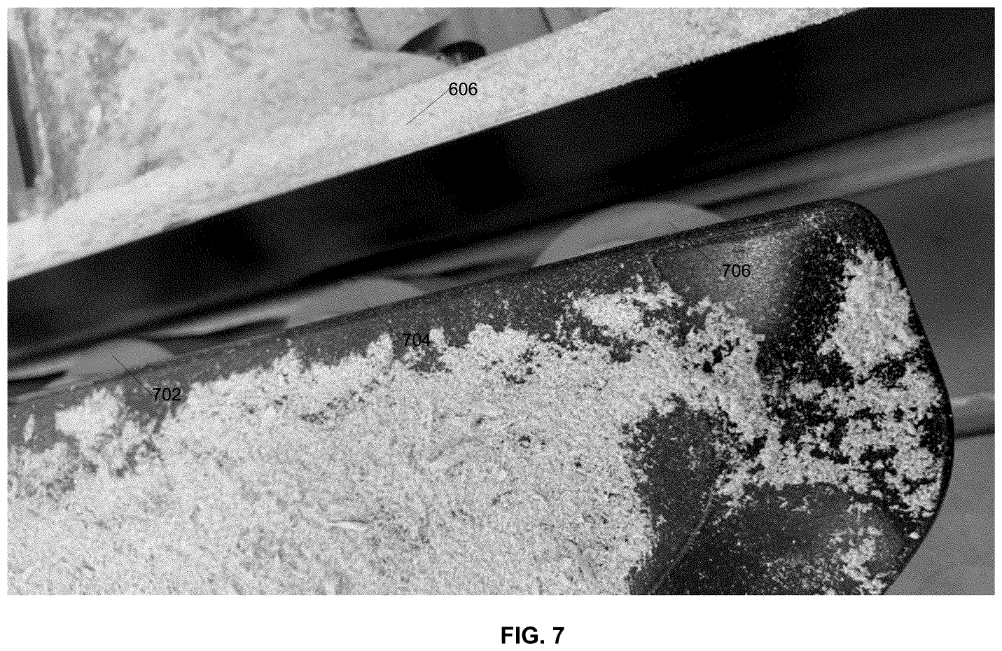

With the fence 406 now set the power feeder 602 can be bolted on the front corner of the shaper closest to the user as illustrated in FIG. 6. With the power feeder 602 mounted via mount 604 it should be rotated until the wheels 702, 704, and 706 in FIG. 7 are positioned such that they can drive product 606 horizontally with the sacrificial fence the second wheel 704 to the right should be placed just to the beginning of the opening created by plunging the running cutter head 402 through the sacrificial fence making sure that the wheel 704 is centered from top to bottom in the center of the apex of the cutter 402 to ensure even pressure ate the point of cut.

Now, in step 110 the depth of the cut can be calibrated using an extra piece of flooring. Rotate the power feeder 602 out of the way to allow access to the cutter 402. Place a piece of tape according to the procedure above across the grain centered at, e.g., 2-½″ from the end of the board. With the machine unplugged and lockout procedures being followed, rotate the cutter head 402 into the extra piece ensuring that the cutter will not cut entirely through the piece but close to it. Rotate the power feeder 602 back to the fence ensuring that all the wheels 702, 704, and 706 are parallel with the fence then retract the feeder until approximately ⅛″ less than the thickness of the flooring is left between the wheels and the fence creating pleasure for the spring-loaded wheel system. Ensuring that all points are secured on the power feeding arm now plug the machine back in and turn it on. Also turn the power feeder on with the wheels turning so that they are pushing the product into the spinning cutter head. The second feeder wheel 704 from the right will be getting cut by the cutter. This insures pressure at the point of cut.

After the piece has been run through and come out the other end inspect the cut. The piece should easily break under very light pressure but not be floppy after it has had the relief cut on the back side. If it is floppy or cut completely through, the cutter 402 is protruding too far through the sacrificial fence and the fence 404 should be brought out farther to reduce the amount of material being removed by the cutter 402. If the piece doesn't break easily or at all, the fence should be brought back farther to expose more of the cutter 402 and increase the depth of its cut. This can be done using the cross grain because calibrating using cross grain is a much smaller window, revealing a more accurate break point for the material.

The shapers sacrificial fence can be made 8′ long being placed directly on the top of the shaper and then having runners placed on the bottom of the end where it extends past the shaper table to support longer pieces as illustrated in FIG. 6.

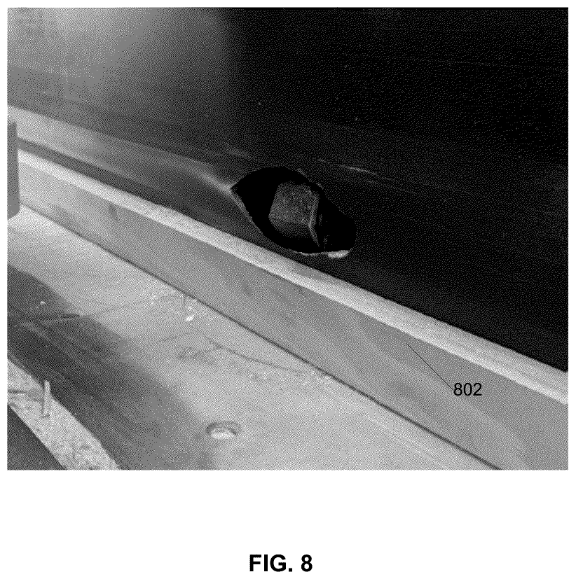

With the shaper and power feed set and calibrated to the thickness of the wood, the taped product can now be run through with the finished face away from the fence to create the miters in step 112. One pass with the shaper set as is, then the second pass with a 1-½″×8′ filler strip 802 added to the table of the shaper to adjust the height reference from 2-½″ to 1″ as illustrated in FIG. 8. This gives two cuts with their points of reference at 1″ and 2-½″ creating the fold points and finished product of 1″ bottom return and 1-½″ front face.

With both passes through the shaper completed, the pieces can be laid flat with the finished face down exposing the cut area. Two beads of glue can now be put into each shaped miter cut: One bead directly in the deepest part of the miter where the two points of the 45-degree cuts meet and one on the surface of one side of the cut. The bead in the point of the miter ensures glue in the sharpest point and back making sure that there are no weak points near the front edge.

Moving quickly with the glue still wet, the two miters can be folded over utilizing the tape and minimal wood left on the face as a hinge now creating the nose. At this point clamp the miter to allow it to dry. One option, for example, is to use 2″ pinch clamps approximately 6″-8″ apart from each other. Another example option is to use an 18-gauge pin gun to shoot through the bottom of the nose to hold the miters closed.

Allow the glue to dry a minimum of 8 hours. After the glue is dry if pinched clamps have been used, they can now be removed. The two pieces of tape that were used as the hinge can now be removed. With the tape removed use a compact router with a ⅛″ round over bit and a flush bearing to add a ⅛″ round profile to the top and bottom of the nosing. Using 100 grit sand paper lightly sand off the milling marks left by the router bit.

Single End Return Tread Procedure with Waterfall Vertical Grain

As describe above in step 102, framing measurements are again confirmed on site. The depth of the tread blank to be glued up can be calculated as the framing depth plus the thickness of the material being used for the riser, assuming the riser will be placed behind the back edge of the nose, plus e.g., 3-½″, plus the desired amount of stair protruding past the back of the framing. For example, if the framing is 10″ and the flooring is being used as the riser and it was ⅝″ and there was 1-½ desired past framing the glue up blank would be 10″+⅝″+3-½″+1-½″=15-⅝″.

Next, ensure the glue up stays flat wile drying. Then choose which edge and end will be referenced through the shaper and cut the appropriate end (left end or right end return) Square to the face. Tape two strips, e.g., of FrogTape across the front edge of the tread typical to a straight nosing then tape two trips across the end referencing the same 1″ and 2-½″ center points.

Set and calibrate the shaper the same way you would for a straight nose. Then turn the shaper and power feeder in in the same fashion as a single straight nose. The glue can then be fed up through the shaper without the 1-½″ filler referencing 2-½″ point. First the length with the grain then secondly across the grain. Typically, as with the straight nose add the 1-½″ filler to create the 1″ reference from the bottom to the apex of the miter cut. Now the same part can be run through the shaper once again running the long edge with the direction of the grain followed second by running the part on its end cutting across the grain.

With all shaper cuts completed the outside corner can now be created on the miter saw. Thus, the miter saw can be set to, e.g., 45 degrees to either the left or the right according to the stairs left or right orientation. The shaped tread can then be placed on the miter saw face down and cut. After cutting fold both the front and end up and confirm that the miters on the bottom align tightly.

To assemble the end return the same procedure can be used as the straight nosing while adding the same process to the end piece that has also been shaped. In addition to the glue process in the miters also glue across the flats where the two miters meet. Then, a veneer ⅛″ thick can be ripped from the provided flooring material slightly larger than the thickness of the tread typically 1-½″ so 1- 9/16″ then cross cut the veneer to 1- 1/16″ then it can be glue on to the end of the tread after the tread has been ripped to desired width using frog tape and thumb pressure. Route all exposed mitered corners typically to the straight procedure.

### Second End Return Options Using Horizontal Grain

The second option provides the client with a different look of horizontal grain following the front grain around the side. First, a tread cutting the front edge in the same fashion as a nose or tread can be created. Then, miter cut the end that will be returned face down on the miter saw cutting a 45 degree. Then cross cut the end of the tread utilizing a cross cut sled or a track saw or a CNC or sliding table saw at 45 degrees.

Once that is complete run more material (enough for the desired length of the end return and the amount of end returns desired) ripped to 2-½″ through the shaper utilizing the same procedures as a nosing. Once run fold the shaped piece to 90 degrees using the tape hinge. With the 1″ face down on the chop saw and the 1-½″ face vertical away from the fence facing you with the sharp miter up. Set the miter saw to 45 degrees either left or right depending on the stair orientation. Fold the nose over on the tread to create the 2 90 degree folds then add the return end tight at the miter and tape the added piece to be create the end return. Typically assemble with glue and clamps.

### Third End Return Option Linear End Return

Here, run a nose in typical fashion. With the nose face down determine the location of the secondary fold. Using a router or CNC with a sharp pointed 90 degree “V” groove cutter to cross cut all but 0.007″ through the piece from top to bottom then cut a 90 notch in the 1″ bottom piece and top piece of the tread using the intersection where the “V” intersects at the 1-½″ piece and the top of the trad and where it intersects the 1″ bottom return. Assemble folding the nose as typical and also at the grooved cross cut and clampo together using tape.

### Vinyl Nosing Procedure

Here, set up shaper in typical format to an engineered wood tread. The only difference is to stack 2 Magnate brand (M039 V-Groove Shaper Cutter—90 degree; 1″ Cutting height; ¾″ bore) using a shim inbetween them creating a 1-⅜″ spread between the apexes of the cutter. 1-⅜ is used instead of 1-½ because the 0.060 material left on the flooring face adds to the fold resulting in a 1-½″ outside dimension. Before installing the cutter all three of the points of the cutter need to filed to a flat 0.040″. This allows the vinyl to fold without a sharp point removing the issue of white stress marks on the outside corners.

Tape is not used on vinyl nosings. The amount of material left on the flooring is sufficient to act as a hinge. Set the shaper typical to an engineered wood nosing only difference is to leave 0.060-0.065 amount of material on the face measured with machinist calipers (FIG. 20). Run the part once across the stock table and once across the 1-½″ build up to reference the apex of the cut at 1″.

Measure the flat created between the two miter cuts and cut a piece of plywood to match thickness. Utilizing the MPI Moreheat heat bar set to 210 degrees Fahrenheit lay the product face down ensuring that the two miter cuts are fully over the bare. Let it sit for 1 minute and then ad Fastcap brand 2P10 Thick glue in the miter and on the flat where the plywood filler will interface.

While still on heat fold the bottom edge of the tread up and over the plywood filler then place the piece into a powder coated steel or aluminum form with a square configuration and a 1-½″ inside dimension clamping from the backside against the plywood pushing forward into the 1-½″ face and allow to dry and the vinyl to cool into position.

### Waterfall End Return

Create a waterfall end return by clicking together and gluing multiple pieces of flooring to achieve the desired width of end return then run through the shaper the end that is desired to be returned along with the face edge of the tread.

Place face down and using either a router or CNC notch out the corner to allow the miters to all fold on themselves.

### Linear end Return

Cut the flooring as typical through the shaper. Once that is complete place face down and cut similar to the wood technique.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the embodiments described herein or the application and uses thereof. Hence, although the present embodiments are, for convenience of explanation, depicted and described as being implemented in a method for manufacturing hardwood nosing, it will be appreciated that it can be implemented in various other types of method for manufacturing hardwood nosing, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A method for manufacturing hardwood nosing, comprising: confirming stair opening or landing surround measurements onsite;
cut the flooring board to be used to create the nose;
run two pieces of tape the length of the flooring board on the face of the flooring with a center line of each piece of tape approximately arranged at the centerline of each miter cut as illustrated;
set up a shaper to remove the material from the flooring board to create the miter fold;
calibrate the depth of the cut; and
create the miter.

2. The method of claim 1, further comprising increasing the measurement taken on site.

3. The method of claim 2, wherein the measurement taken on site is increased by at least 2″.

4. The method of claim 2, wherein the measurement taken on site is increased by no more than 2″.

5. The method of claim 2, wherein the measurement taken on site is increased by at least 4″.

6. The method of claim 2, wherein the measurement taken on site is increased by no more than 4″.

7. The method of claim 1, wherein the flooring board is only cut if it is over the required nosing size.

8. The method of claim 7, wherein the required size is 14″.

9. The method of claim 1, wherein the center lines are at 1″ and 2-½″ from the edge referenced on a shaper table being used.

10. The method of claim 1, further comprising, after the tape has been placed on the flooring board pressing firmly on the tape, such that it can act as a hinge for the product to fold against.

11. The method of claim 1, wherein the shaper is set up with a custom built 3 wing cutter head.

12. The method of claim 1, wherein setting up the shaper comprises setting the apex of the cutter at 2-½″ from a table top of the shaper.

13. The method of claim 11, wherein setting up the shaper further comprises adding a sacrificial fence to the shaper.

14. The method of claim 12, wherein the sacrificial fence is made of ¾″ engineered product with a slick face surface.

15. The method of claim 13, wherein setting up the shaper further comprises aligning a shaft of the shaper with the sacrificial fence, and cutting a relief in the back of the sacrificial fence to allow the cutter to protrude through the sacrificial fence.

16. The method of claim 14, wherein setting up the shaper further comprises turning the shaper on and slowly allowing the cutter to plunge through the sacrificial fence until inserts are protruding to the maximum thickness of material desired to be cut.

17. The method of claim 1, wherein creating the miter comprises running the taped flooring board through with a finished face away from a sacrificial fence.
